(19) United States
(12) Patent Application Publication
(10) Pub. No.: US 2025/0174938 A1
(43) Pub. Date: May 29, 2025

(54) Connector Assembly

(71) Applicant: Aptiv Technologies AG, Schaffhausen (CH)

(72) Inventors: Kevin S. Turner, Vienna, OH (US); Abhaya Kishore, Nagercoil (IN)

(21) Appl. No.: 18/939,738

(22) Filed: Nov. 7, 2024

Related U.S. Application Data
(60) Provisional application No. 63/603,857, filed on Nov. 29, 2023.

(51) Int. Cl. H01R 13/629; H01R 13/633

(52) U.S. Cl. CPC H01R 13/62944; H01R 13/6335; H01R 2201/26

(57) ABSTRACT

A connector assembly includes a first connector, a lever, and a second connector. The first connector includes a first lock surface. The lever is rotatably-coupled to the first connector and includes a second lock surface and a release surface. The second lock surface is configured to engage the first lock surface in a locked orientation. The second connector is configured to mate with the first connector.

### CROSS-REFERENCE TO RELATED APPLICATIONS

This application claims the benefit of U.S. Provisional Application No. 63/603,857 filed Nov. 29, 2023, the entire disclosure of which is incorporated by reference.

### FIELD

The present disclosure relates to a connector assembly and more particularly to a connector assembly having a lever lock and a pre-stage locking feature for the lever lock.

### BACKGROUND

Modern vehicles (e.g., automobiles) rely on electrical wiring and electrical connections to facilitate communication between various electronic components within the vehicle. Connection systems (e.g., connectors and terminals) play an important role in ensuring the integrity of these electrical connections and the reliability and performance of the vehicle. Some connectors use a lever-type locking mechanism to securely fasten mating connectors together during assembly. In some situations, it is desirable to secure the lever in a specific orientation before final assembly. Current designs may require slides, features on wiredress covers, or manual attention to secure the lever in preferred orientations. These known features and methods can lead to inefficiencies for assembly technicians in the assembly process. In view of the foregoing, while known lever-type locking mechanisms for vehicle connection systems have proven acceptable for their intended purpose, a continuous need for improvement remains in the pertinent art to address the challenges associated with pre-assembly positioning of the lever lock.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a connector assembly including a first connector, a lever, and a second connector. The first connector includes a first lock surface. The lever is rotatably-coupled to the first connector and includes a second lock surface and a release surface. The second lock surface is configured to engage the first lock surface in a locked orientation. The second connector is configured to mate with the first connector.

Another aspect of the disclosure provides a connector assembly including a first connector and a lever. The first connector includes a first projection having a first lock surface. The lever is rotatably-coupled to the first connector and includes a flexible locking arm having second lock surface extending in a first direction. The second lock surface is configured to engage the first lock surface in a locked orientation to inhibit rotation of the lever relative to the first connector.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of a connector assembly in accordance with the principles of the present disclosure.

FIG. 2 is an exploded view of the connector assembly of FIG. 1.

FIG. 3A is cross-sectional view of the connector assembly of FIG. 1 in a stage of an assembly process with a mating connector in accordance with the principles of the present disclosure.

FIG. 3B is cross-sectional view of the connector assembly of FIG. 1 in another stage of an assembly process with a mating connector in accordance with the principles of the present disclosure.

In the drawings, reference numbers may be reused to identify similar and/or identical elements.

### DETAILED DESCRIPTION

### Introduction

A system and method are provided for locking a mechanical assist lever of a connector assembly without a wiredress cover in an open/prestage position during handling and after installation of the connector assembly onto an electrical harness. The lever may remain locked in the prestage position until properly inserted into a mating connector shroud. In some implementations, the connector assembly includes features on the lever (e.g., a lock arm) and a body (e.g., lock tab) of the connector assembly to hold the lever in the prestage position. For example, the features may hold the lever in the open/prestage position and move the lever once the connector assembly is in the correct mating position. In particular, during insertion of the connector assembly into the mating shroud of the mating connector assembly, a lock arm feature of the mating shroud of the mating connector assembly may come into contact with the lock arm of the lever. Contact between the lock arm feature and the lock arm may deflect the lock arm and (i) release the locking engagement between the lock arm and the body of the connector assembly and (ii) apply a force on the lever such that the lever moves (e.g., rotates) in a direction that facilitates mating of the connector assembly with the mating connector assembly. This movement (e.g., rotation) of the lever can provide an indication to the operator that the connector assembly is in the correct position for movement (e.g., rotation) of the lever in a direction to complete the mating of the connector assembly with the mating connector assembly.

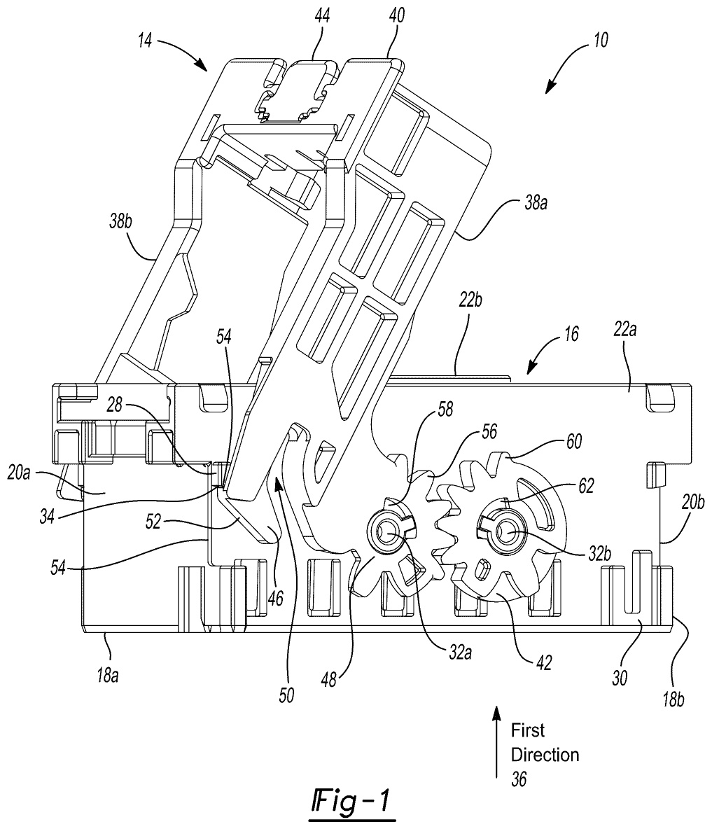

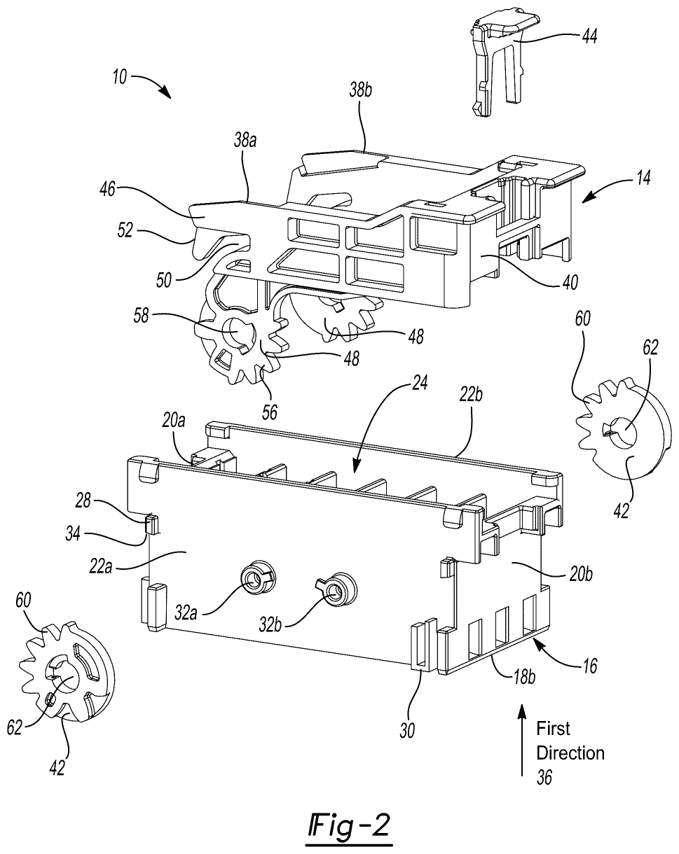

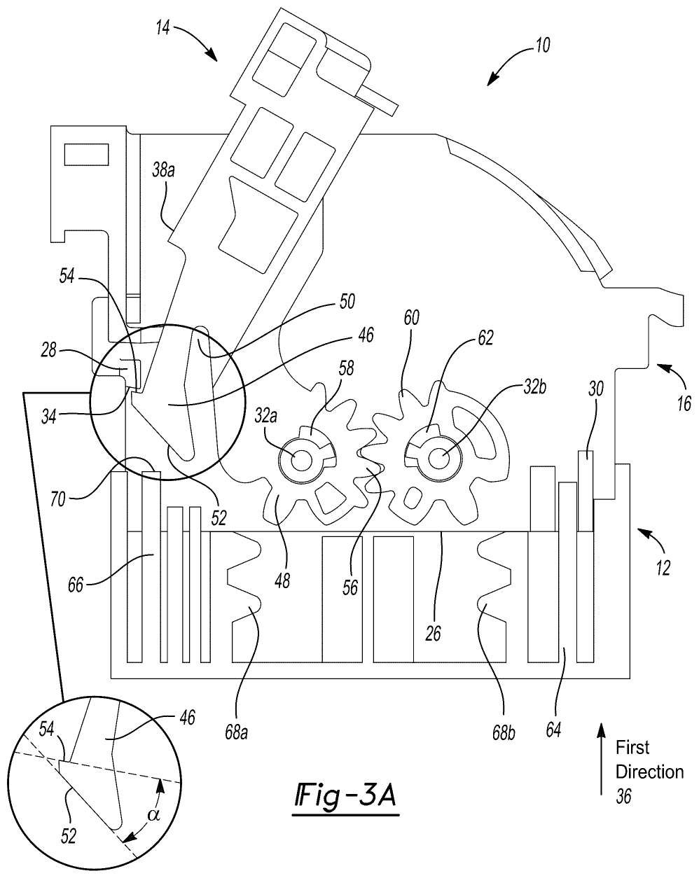

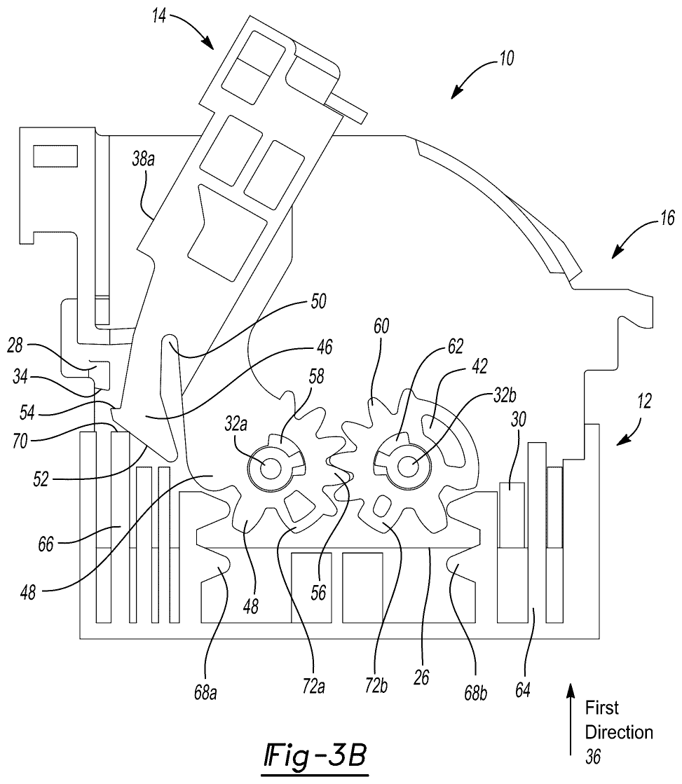

With reference to FIG. 1, a connector assembly 10 is shown. As will be explained in more detail below, the connector assembly 10 may be installed in a vehicle (e.g., an automobile) to facilitate the transmission of electricity between various electronic components within the vehicle. For example, the connector assembly 10 may be detachably coupled to a mating connector assembly 12 (FIGS. 3A-3B) such that, during operation, of the vehicle, electricity is transmitted between the connector assemblies 10, 12 and to various electronic components within the vehicle. Referring to FIGS. 1 and 2, the connector assembly 10 may include a lever assembly 14 and a connector body 16. The lever assembly 14 may be rotatably-coupled to the connector body 16.

The connector body 16 (i.e., a connector housing) may include a first end 18a, a second end 18b spaced apart from the first end 18a, a first end wall 20a, a second end wall 20b spaced apart from the first end wall 20a, a first sidewall 22a disposed between the first end 18a and the second end 18b, and/or a second sidewall 22b spaced apart from the first sidewall 22a, among others. The first end wall 20a may be disposed proximate the first end 18a and the second end wall 20b may be disposed proximate the second end 18b. The first end wall 20a, the second end wall 20b, the first sidewall 22a, and the second sidewall 22b may collectively define a cavity 24 and an opening 26 (FIG. 3A) in communication with the cavity 24. As will be explained in more detail below, in an assembled configuration, the opening 26 and/or the cavity 24 may receive the mating connector assembly 12.

The connector body 16 may include a lock tab 28, an alignment feature 30, and one or more gear retention features 32a, 32b. The lock tab 28 may protrude from one or more of the end walls 20a, 20b or sidewalls 22a, 22b. As illustrated in FIG. 1, in some implementations, a first lock tab 28 extends outwardly from the first sidewall 22a and a second lock tab 28 extends from the second sidewall 22b. In particular, the lock tab 28 may extend from a location where the first sidewall 22a or the second sidewall 22b meets the first end wall 20a. The lock tab 28 may include a bottom surface 34 facing the opening 26 and/or a first direction 36.

The alignment feature 30 may include a set of protrusions protruding from the first sidewall 22a and/or the second sidewall 22b and extending in a direction substantially (+/−10 degrees) parallel to the first direction 36. In this regard, the alignment feature 30 may be referred to herein as the protrusions 30. In some implementations, the protrusions 30 extend from a location where the first sidewall 22a or the second sidewall 22b meets the first end wall 20a and/or the second end wall 20b.

The gear retention features 32a, 32b may include cylindrical hubs extending from the first sidewall 22a and/or the second sidewall 22b. In this regard, the gear retention features 32a, 32b may be referred to herein as the gear hubs 32a, 32b. The gear hubs 32a, 32b may be disposed between the first end wall 20a and the second end wall 20b along the first sidewall 22a and/or the second sidewall 22b.

The lever assembly 14 may be detachably and rotatably coupled to the connector body 16 and may include a first lever arm 38a, a second lever arm 38b, a base 40, a body gear 42, and a connector position assurance (CPA) device 44. As illustrated in FIG. 2, in some implementations, portions of the lever assembly 14 (e.g., the first lever arm 38a, the second lever arm 38b, the base 40, and the body gear 42) form an integral and/or monolithic construct.

The second lever arm 38b may be spaced apart from and substantially (e.g., +/−10 degrees) parallel to the first lever arm 38a. The base 40 may be disposed between the first lever arm 38a to the second lever arm 38b. In particular, the base 40 may be connected to an end of the first lever arm 38a and an end of the second lever arm 38b.

Each lever arm 38a, 38b may include a lock arm 46 and a lever arm gear 48. The lock arm 46 and the lever arm gear 48 may be disposed at an end of the lever arm 38a, 38b. In particular, the lock arm 46 and the lever arm gear 48 may extend from the end of the lever arm 38a, 38b opposite from the base 40. The lock arm 46 may be disposed above the lever arm gear 48 such that the lock arm 46 and the lever arm gear 48 define a void 50 therebetween.

The lock arm 46 may include a release surface 52 and a lock surface 54 extending transverse to the release surface 52. In this regard, the release surface 52 and the lock surface 54 may define an angle α therebetween (FIG. 3A). In some implementations, the angle α is between twenty degrees and sixty degrees such that the release surface 52 and the lock surface 54 define a wedge shape. For example, the angle α may be substantially (+/−10 degrees) equal to forty-five degrees.

The lever arm gear 48 may include a plurality of teeth 56 and a center 58. The lever arm gear 48 may be detachably and rotatably coupled to the first sidewall 22a and/or the second sidewall 22b by inserting a gear retention feature 32a, 32b through the center 58 of the lever arm gear 48. As will be explained in more detail below, during a method of operating the connector assembly 10 and the lever assembly 14, the teeth 56 may interface with the body gear 42 and the mating connector assembly 12, as the lever arm 38 is rotated about the gear retention feature 32a, to engage the connector body 16 with the mating connector assembly 12.

The body gear 42 may include a plurality of teeth 60 and a center 62. The body gear 42 may be detachably and rotatably coupled to the first sidewall 22a and/or the second sidewall 22b by inserting a gear retention feature 32a, 32b through the center 62 of the body gear 42. As will be explained in more detail below, during a method of operating the connector assembly 10 and the lever assembly 14, the teeth 60 may interface with the teeth 56 of the lever arm gear 48 and the mating connector assembly 12 to engage the connector body 16 with the mating connector assembly 12.

The CPA 44 may hold the lever assembly 14 in place when the lever assembly 14 is in a fully engaged position. In the fully engaged position, the connector assembly 10 may be fully engaged with the mating connector assembly 12 and the lever assembly 14 may rest on top of the second end wall 20b of the connector body 16.

Referring to FIGS. 3A and 3B, the mating connector assembly 12 may include one or more mating alignment features 64, a lock arm engagement feature 66, and gear engagement features 68a, 68b. The mating alignment features 64 may include one or more protrusions protruding from a wall of the mating connector assembly 12 and extending in a direction substantially (+/−10 degrees) parallel to the first direction 36. In this regard, the mating alignment features 64 may be referred to herein as the mating protrusions 64. During operation of the connector assembly 10, the protrusions 30 and the mating protrusions 64 may engage and/or otherwise interface with one another to ensure proper alignment and connection between the connector assembly 10 and the mating connector assembly 12. In this regard, during assembly of the connector assembly 10 and the mating connector assembly 12, the mating connector assembly 12 may be inserted into the cavity 24 and/or the opening 26 of the connector body 16.

The lock arm engagement feature 66 may include a protrusion protruding from a wall of the mating connector assembly 12 and extending in a direction substantially (+/−10 degrees) parallel to the first direction 36. In this regard, the lock arm engagement feature 66 may be referred to herein as the lock arm protrusion 66. The lock arm protrusion 66 may include an engagement surface disposed at an end 70 of the protrusion 66.

FIG. 3A shows the lever assembly 14 in an open/prestage position. The lever assembly 14 may be locked (i.e. unable to rotate) in the prestage position by features on the lever assembly 14 (e.g., the lock arm 46) coming into contact with features on the connector body 16 (e.g., the lock tab 28). For example, the lock surface 54 of the lock arm 46 may engage the bottom surface 34 of the lock tab 28 to secure the lever assembly 14 in the prestage position. The lever assembly 14 may be in the prestage position before insertion of the mating connector assembly 12 into the connector assembly 10 and may remain in the prestage position during an initial insertion of the mating connector assembly 12 into the connector assembly 10.

FIG. 3B shows the mating connector assembly 12 partially inserted into the connector assembly 10. As the mating connector assembly 12 is inserted into the connector assembly 10, the lock arm 46 may engage the lock arm engagement feature 66. Specifically, as the connector assembly 10 and/or the mating connector assembly 12 is moved in a direction substantially (+/−10 degrees) parallel to the first direction 36, the release surface 52 of the lock arm 46 may engage the end 70 of the lock arm engagement feature 66. The configuration (e.g., the angle α) of the release surface 52 relative to the lock surface 54 may allow the lock arm engagement feature 66 to slide relative to the release surface 52 during engagement therebetween, such that the lock arm engagement feature 66 deflects the lock arm 46 in a direction towards the lever arm gear 48 and away from the lock tab 28. In this regard, as the connector assembly 10 and/or the mating connector assembly 12 is moved in a direction substantially (+/−10 degrees) parallel to the first direction 36, the lock surface 54 of the lock arm 46 may disengage from the bottom surface 34 of the lock tab 28 such that the lever assembly 14 is released from the prestage position.

Engagement of the lock arm 46 with the lock arm engagement feature 66 may also apply a force on the lever assembly 14 in a direction substantially parallel to the first direction 36 such that the lever assembly 14 moves (e.g., rotates) in a direction (e.g., clockwise relative to FIG. 3B) that facilitates engagement of the connector assembly 10 with the mating connector assembly 12. In particular, the lock arm engagement feature 66 may apply a torque on the lever assembly 14 that causes the lever assembly 14 to rotate about the gear engagement feature 68a. Rotation of the lever assembly 14 can provide an indication to an operator that the connector assembly 10 is in the correct position for movement (e.g., rotation) of the lever assembly 14 in a direction (e.g., clockwise relative to FIG. 3B) to complete the mating of the connector assembly 10 with the mating connector assembly 12.

As the lever assembly 14 starts to rotate, the lever arm gear 48 may mesh with the body gear 42, and both gears 48, 42 may mesh with the gear engagement features 68a, 68b of the mating connector assembly 12. The gears 48, 42 may only mesh with the gear engagement features 68a, 68b if the connector assembly 10 is in the correct position to complete mating with the mating connector assembly 12. The gears 48, 42 may include stop features 72a, 72b. The stop features 72a, 72b may prevent the lever assembly 14 from further rotating in a direction (e.g., clockwise relative to FIG. 3B) when the connector assembly 10 is fully mated with the mating connector assembly 12. In this regard, rotation of the lever assembly 14 may be complete when the lever assembly 14 rests on top of the second end wall 20b of the connector body 16 and/or when the stop features 72a, 72b come into contact with the gear engagement features 68a, 68b on the mating connector assembly 12.

When the connector assembly 10 is fully engaged with the mating connector assembly 12, electricity may be transmitted between the connector assemblies 10, 12 and to various electronic components within the vehicle.

The following Clauses provide an exemplary configuration for a connector assembly and related methods, as described above.

Clause 1: A connector assembly comprising: a first connector including a first lock surface; a lever rotatably-coupled to the first connector and including a second lock surface and a release surface, the second lock surface configured to engage the first lock surface in a locked orientation; and a second connector configured to mate with the first connector.

Clause 2: The connector assembly of clause 1, wherein: the second lock surface extends in a first direction; and the release surface extends in a second direction transverse to the first direction.

Clause 3: The connector assembly of clauses 1 or 2, wherein the second connector includes a projection configured to engage the release surface and disengage the second lock surface from the first lock surface.

Clause 4: The connector assembly of clause 3, wherein the projection on the second connector is configured to apply a force on the release surface and rotate the lever in a third direction.

Clause 5: The connector assembly of any of clauses 1 through 4, wherein: the first connector includes a first alignment feature; and the second connector includes a second alignment feature configured to mate with the first alignment feature and align the first connector with the second connector.

Clause 6: The connector assembly of any of clauses 1 through 5, wherein: the first connector includes a first gear; and the lever includes a second gear configured to mate with the second gear.

Clause 7: The connector assembly of clause 6, wherein: the first gear includes a first stop feature; the second gear includes a second stop feature; and the first stop feature and the second stop feature are configured to inhibit rotation of the lever by contacting the second connector.

Clause 8: The connector assembly of any of clauses 1 through 7, wherein: the first connector includes a third lock surface; the lever includes a fourth lock surface and a second release surface; and the fourth lock surface is configured to engage the third lock surface in the locked orientation.

Clause 9: The connector assembly of clause 8, wherein: the first lock surface is located on a first side of the first connector; the third lock surface is located on a second side of the first connector; and the first side is opposite the second side.

Clause 10: The connector assembly of clauses 8 or 9, wherein: the second lock surface is located on a first arm of the lever; and the fourth lock surface is located on a second arm of the lever.

Clause 11: A connector assembly comprising: a first connector including a first projection having a first lock surface; and a lever rotatably-coupled to the first connector and including a flexible locking arm having second lock surface extending in a first direction, wherein the second lock surface is configured to engage the first lock surface in a locked orientation to inhibit rotation of the lever relative to the first connector.

Clause 12: The connector assembly of clause 11, wherein the lever includes a release surface extending in a second direction transverse to the first direction.

Clause 13: The connector assembly of clauses 11 or 12, further comprising a second connector configured to mate with the first connector.

Clause 14: The connector assembly of clause 13, wherein the second connector includes a second projection configured to engage the release surface and disengage the second lock surface from the first lock surface.

Clause 15: The connector assembly of clause 14, wherein the second projection is configured to apply a force on the release surface and rotate the lever in a third direction.

Clause 16: The connector assembly of any of clauses 11 through 15, wherein: the first connector includes a first alignment feature; and the second connector includes a second alignment feature configured to mate with the first alignment feature and align the first connector and the second connector.

Clause 17: The connector assembly of any of clauses 11 through 16, wherein: the first connector includes a first gear; and the lever includes a second gear configured to mate with the first gear.

Clause 18: The connector assembly of any of clauses 11 through 17, wherein: the first connector includes a third projection having a third lock surface; the lever includes a fourth lock surface and a second release surface; and the fourth lock surface is configured to engage the third lock surface in the locked orientation.

Clause 19: The connector assembly of clause 18, wherein: the first projection is located on a first side of the first connector; the third projection is located on a second side of the first connector; and the first side is opposite the second side.

Clause 20: The connector assembly of clauses 18 or 19, wherein: the second lock surface is located on a first arm of the lever; and the fourth lock surface is located on a second arm of the lever.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set-in other words, in some circumstances a “set” may have zero elements. The term “non-empty set” may be used to indicate exclusion of the empty set-in other words, a non-empty set will always have one or more elements. The term “subset” does not necessarily require a proper subset. In other words, a “subset” of a first set may be coextensive with (equal to) the first set. Further, the term “subset” does not necessarily exclude the empty set-in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

What is claimed is:

1. A connector assembly comprising:
a first connector including a first lock surface;
a lever rotatably-coupled to the first connector and including a second lock surface and a release surface, the second lock surface configured to engage the first lock surface in a locked orientation; and
a second connector configured to mate with the first connector.

2. The connector assembly of claim 1, wherein:
the second lock surface extends in a first direction; and
the release surface extends in a second direction transverse to the first direction.

3. The connector assembly of claim 1, wherein the second connector includes a projection configured to engage the release surface and disengage the second lock surface from the first lock surface.

4. The connector assembly of claim 3, wherein the projection on the second connector is configured to apply a force on the release surface and rotate the lever in a third direction.

5. The connector assembly of claim 3, wherein:
the first connector includes a first alignment feature; and
the second connector includes a second alignment feature configured to mate with the first alignment feature and align the first connector with the second connector.

6. The connector assembly of claim 1, wherein:
the first connector includes a first gear; and
the lever includes a second gear configured to mate with the second gear.

7. The connector assembly of claim 6, wherein:
the first gear includes a first stop feature;
the second gear includes a second stop feature; and
the first stop feature and the second stop feature are configured to inhibit rotation of the lever by contacting the second connector.

8. The connector assembly of claim 1, wherein:
the first connector includes a third lock surface;
the lever includes a fourth lock surface and a second release surface; and
the fourth lock surface is configured to engage the third lock surface in the locked orientation.

9. The connector assembly of claim 8, wherein:
the first lock surface is located on a first side of the first connector;
the third lock surface is located on a second side of the first connector; and
the first side is opposite the second side.

10. The connector assembly of claim 8, wherein:
the second lock surface is located on a first arm of the lever; and
the fourth lock surface is located on a second arm of the lever.

11. A connector assembly comprising:
a first connector including a first projection having a first lock surface; and
a lever rotatably-coupled to the first connector and including a flexible locking arm having second lock surface extending in a first direction, wherein the second lock surface is configured to engage the first lock surface in a locked orientation to inhibit rotation of the lever relative to the first connector.

12. The connector assembly of claim 11, wherein the lever includes a release surface extending in a second direction transverse to the first direction.

13. The connector assembly of claim 12, further comprising a second connector configured to mate with the first connector.

14. The connector assembly of claim 13, wherein the second connector includes a second projection configured to engage the release surface and disengage the second lock surface from the first lock surface.

15. The connector assembly of claim 14, wherein the second projection is configured to apply a force on the release surface and rotate the lever in a third direction.

16. The connector assembly of claim 14, wherein:
the first connector includes a first alignment feature; and
the second connector includes a second alignment feature configured to mate with the first alignment feature and align the first connector and the second connector.

17. The connector assembly of claim 11, wherein:
the first connector includes a first gear; and
the lever includes a second gear configured to mate with the first gear.

18. The connector assembly of claim 11, wherein:
the first connector includes a third projection having a third lock surface;
the lever includes a fourth lock surface and a second release surface; and
the fourth lock surface is configured to engage the third lock surface in the locked orientation.

19. The connector assembly of claim 18, wherein:
the first projection is located on a first side of the first connector;
the third projection is located on a second side of the first connector; and
the first side is opposite the second side.

20. The connector assembly of claim 18, wherein:
the second lock surface is located on a first arm of the lever; and
the fourth lock surface is located on a second arm of the lever.
